(19) United States
(12) Patent Application Publication
(10) Pub. No.: US 2020/0394238 A1
(43) Pub. Date: Dec. 17, 2020

(54) Method for Creating and Using an Honesty and Credibility Rating System

(71) Applicant: Craig Thomas Ellrod, CASTLE ROCK, CO (US)

(72) Inventor: Craig Thomas Ellrod, CASTLE ROCK, CO (US)

(21) Appl. No.: 16/825,960

(22) Filed: Mar. 20, 2020

Related U.S. Application Data
(60) Provisional application No. 62/860,096, filed on Jun. 11, 2019.

(51) Int. Cl. G06F 16/9535; G06F 21/45

(52) U.S. Cl. CPC G06F 16/9535; G06F 21/45

(57) ABSTRACT

A method creates an honesty and credibility rating for a user. The method utilizes an algorithm to rate the user based on the information in any user data and/or records. The algorithm assigns an initial rating and subsequently subtracts from or adds to the initial rating a predetermined number of points for each negative and/or positive occurrence in the data and/or records. The method then creates and provides to the user an obfuscated identity that combines the rating with a variety of physical and/or digital identification means such as a wearable badge, a graphical identification, a QR (Quick Response) code, a webpage link, etc. Additionally, the method may remove some or all personally identifiable information for the protection of the user's sensitive information. Thus, the method provides a safe and secure honesty and credibility rating to be used by users to wear and display through physical appearance, digitally, online and social media postings.

The current application claims a priority to the U.S. Provisional Patent application Ser. No. 62/860,096 filed on Jun. 11, 2019.

### FIELD OF THE INVENTION

The present invention relates generally to rating methods and systems. More specifically, the present invention relates to a method for creating and using an honesty and credibility rating system for a user. The method combines the information of a credit score and background check report of the user and creates a unique rating for the user utilizing an innovative identity authentication technique. The resulting rating can then be used to represent the user's honesty and credibility with a wearable badge, a graphical identification, a QR (Quick Response) code, a webpage link, etc.

### BACKGROUND OF THE INVENTION

Being honest and credible means being free of deceit, being fair, truthful and sincere, being morally correct and virtuous, being able to be believed and convincing, telling and expressing the truth. Honesty and credibility promote openness, empower people to develop consistency in how people present the facts. Through honesty and credibility, people establish trust between each other, form unique and unwavering bonds of mutual respect. People come to rely on one another and value their opinions over time as a result of this foundation. In effect, people establish credibility among their peers in regard to knowledge, point of view and unfaltering truth. Normally, people want to know who they are dealing with in any kind of interaction such as borrowing money, entering a contractual relationship, trading goods, exchanging ideas, even dating, etc. If there are issues, people usually investigate the attributes involving honesty and credibility of others before they spend valuable time and resources to start the relationship or interaction. Additionally, there are people out there that prey on and use honest people to benefit themselves for significant financial and societal gains. Further, people may find themselves in a position to end up with a criminal charge, or bad credit at the hand of another person that did not recognize the duty to inform of their past and character.

However, there is no efficient and effective system or method for rating the honesty and credibility of an individual even though substantial emphasis and efforts are constantly expended in numerous fields and professions in attempts to identify these characters of people. Every year, companies and businesses spend tremendous human resources to seek candidates possessing attributes related to honesty and credibility during many hiring processes. Constraints on time and resources, however, can often prevent an employer from being able to fully investigate or verify assumptions that are initially made during the interview process regarding a candidate's honesty and credibility. Similar problems are also experienced by venture firms and angel investors who spend significant efforts in deciding whether to invest money in a particular project or person. Investors, like employers, want to invest in companies and individuals that possess the valued attributes that are related to credibility. Possession of these attributes, however, can be difficult to determine and can be even more difficult to verify. It is well known that having honesty and credibility in the workplace is one of the most important qualities of great leadership in business.

There is an example where a Real Estate broker hired several employees to sell and process mortgage loans through credit unions in Southern California. After a couple of years, one employee found out that the owner was convicted of Real Estate crimes, had his Real Estate license revoked and was using a friend's license to conduct business. The owner promised riches but never delivered, spending all of the money on his lavish lifestyle. If this invention had been available then, it would have saved at least one employee two years of wasted effort, their career and financial losses.

There is another example in Colorado, whereby a potential business owner was creating a Cybersecurity services startup. Six months into the venture, one partner discovered, through his own expense, that the founder had nine criminal records, including tax liens, bankruptcies, driving without insurance, and other criminal charges which he pled guilty to. This invention could have saved the honest partner six months of wasted time and financial investment.

There is another example where a couple were dating and getting ready to get married. When one partner asked the other partner about their credit, they lied and said it was good. After getting married, the honest partner discovered the dishonest partner had lied, had creditors chasing them and later had to file for bankruptcy. After getting married to the honest partner, the dishonest partner also purchased a time share unit and did not tell the honest partner about it for four years. This purchase became a liability to the honest partner. This invention would have saved the honest partner from entering into a turbulent, financially messy marriage that lasted ten years.

There are many examples of temporary winners in business who won by cheating. For example, Enron was cited as one of America's most innovating and daring companies for a number of years. The CEO of the company knew the most important people in the country, including the President of the United States. Enron's temporary success, however, was built on lies, and the “winners” who headed the company are case studies in lack of integrity and brought the company to destruction.

Existing methods related to rating and reporting honesty and credibility of people include background check report, credit report, various polls, survey systems, etc. All these methods do not provide a rating for individuals with regard to honesty and credibility attributes. For example, background checks are often requested by employers on job candidates for employment screening, especially on candidates seeking a position that requires high security or a position of trust, such as in a school, courthouse, hospital, financial institution, airport, and government. These checks are traditionally administered by a government agency for a nominal fee but can also be administered by private companies. Results of a background check typically include past employment verification, credit history, and criminal history. The objective of background checks is to ensure the safety and security of the employees in an organization.

The uniqueness of the present invention is that the present invention puts the capability and responsibility of reporting an entity's honesty and credibility on the individual entity, as opposed to leaving it up to the other parties to investigate at the other parties' expenses. Users and entities need to own their behavior, honesty and credibility, and are responsible for letting others know up front.

Another example is credit reports. A credit report is a detailed breakdown of an individual's credit history prepared by a credit bureau such as Equifax, Experian, and TransUnion. The credit bureau collects financial information about an individual and creates a credit report based on that information, and lenders use the report along with other information to determine the creditworthiness of the individual for purposes such as loan application. The credit report normally includes personal information such as the individual's current and previous addresses, social security numbers and employment history. Additionally, the credit report includes a credit history summary such as the number and type of bank or credit card accounts that are past due or in good standing, and detailed account information related to high balances, credit limits and the date accounts were opened. The credit report also lists credit inquiries and details of accounts turned over to credit agencies such as information about liens and wage garnishments. Generally, the credit report retains negative information for seven years, while bankruptcy filings typically stay on credit reports for about 10 years. Based on the credit report, a credit score is calculated with a formula based on variables including payment history, the number of accounts, and the amounts owed, your credit score may affect the interest rate you pay to a lender and even make the difference between a loan being approved or declined. Your credit score is a number that represents the risk a lender takes when you borrow money at a moment in time, the higher the credit score, the lower the risk to the lender.

Other examples of rating and reporting honesty and credibility of people include Gallup polls and custom online rating systems. The Gallup Poll Social Series (GPSS) is a set of public opinion surveys designed to monitor U.S. adults' views on numerous social, economic, and political topics. In 2016, GPSS conducted telephone interviews with a random sample of 1,028 adults, aged 18+, living in all 50 U.S. states and the District of Columbia, and concluded that most Americans trust their healthcare providers to be honest and ethical among various fields. Nurses topped the list with 84% of the public rating their standards as “high” or “very high,” while members of Congress fall to the bottom—the only profession for which a majority of Americans (59%) rate honesty and ethical standards as “low” or “very low.” However, GPSS does not conduct honesty and credibility rating/survey for individuals, businesses, and entities.

Most existing online rating systems for honesty and credibility of people, businesses, and entities, focus on the credibility attributes of users who are members registered with their specific services, websites, mobile apps, etc. These systems normally rely on custom designed sets of rules, standards, and parameters to be used in the rating algorithms, which mine data obtained through surveys, reviews, evaluations, rater rating scores, feedbacks, responses, etc. Additionally, exterior and/or publicly available data/information from various database sources. These sources include social networks, email databases, wireless network databases, and Internet address databases. Independent clearinghouses, government agencies and investigative organizations can also be queried or commissioned. However, none of these rating systems provides an integrated rating system using credit report and background check report to identify an entity with an honesty and credibility rating. Additionally, there is currently no rating system for “Social Good” or “Social Credit” that an entity has performed.

Global data privacy and data breaches continue to be a growing and significant problem. Fraud in the digital realm is at epidemic proportions. 25% of Facebook® profiles are fake. 9 to 15% of Twitter® profiles are fake. 10% of Instagram® contains fake profiles. 60% of Internet profiles are fake. 36% of Internet traffic is fake and fraudulent. Data breaches are happening so frequently it is becoming a global epidemic, and no existing system is attempting to prevent the problem from happening in the first place. Digital data privacy and individual entity's rights to that privacy are also becoming an issue of global concern. Examples of existing identity management systems make use of usernames and passwords which can be hacked, stolen and thereby expose entity identifiable information, which can be tied to other sensitive data. The present invention aims to solve this problem by removing the attack surface of identity and entity identifiable information and introduces the unique concept of “obfuscated identity” as a means to positively identify an entity with the honesty and credibility rating, while not revealing any confidential identifying or personal identifying information.

It is an objective of the present invention to provide an innovative honesty and credibility rating system and method. The present invention offers the user, business, or entity with an honesty and credibility rating ranged from a predetermined negative score (e.g. −10) to a predetermined positive score (e.g. 10). The rating is based on the data and information from the background check report and credit report the user supplies. Further, the rating is based on acts of service that the user performs for the greater good of humanity. The method utilizes a unique algorithm to rate the user based on the information and creates an identification code that combines the rating with a profile of the user. Additionally, the method of the present invention may provide a user identification and authentication process that removes all personally identifiable information and the data used for creating the honesty and credibility rating from the user's identity profile for the protection of the user's personal information. Thus, the present invention provides a safe and secure honesty and credibility rating that can be used by individuals to wear and display their honesty and credibility in physical appearance, online display on any websites, automatic posting on all social media apps, etc., without exposing any personally identifiable information.

### SUMMARY OF THE INVENTION

A method of creating an honesty and credibility rating for a user utilizes a unique algorithm that is based on the information in relevant data and/or records of the user. The rating method first acquires such data and/or records through acquisition from external data/record sources and/or prompting the user to upload data and/or record files. The data and/or records used for the honesty and credibility rating of the present invention may include, but not limited to, background check report, credit report, motor vehicle traffic violation record, acts of service that the user performs for the greater good of humanity, etc.

To generate the honesty and credibility rating for the user, the algorithm of the rating method starts with an assignment of an initial (or starting) rating and subsequently subtracts from the initial rating a predetermined number of points for each negative occurrence in the relevant data and/or records for the user. For every positive occurrence in the data and/or records, the rating method adds to the initial rating a predetermined number of points. Subsequently, the rating method can provide the user with the resulting honesty and credibility rating.

Then, the rating method creates and provides to the user an obfuscated identity that combines the honesty and credibility rating with a variety of physical and/or digital identification means such as a wearable badge, a graphical identification, a QR (Quick Response) code, a webpage link, etc. The rating may prompt the user to supply any desired image to create the digital obfuscated identity, embedding/combining the physical/digital image with the QR code, etc.

Further, the rating method may remove all personally identifiable information of the user to protect the user's sensitive information. The at least one set of data used to create the honesty and credibility rating for the specific user may also be removed. Thus, the rating method or the present invention provides a safe and secure honesty and credibility rating to be used by users to wear and display through physical appearance, online and social media postings.

### BRIEF DESCRIPTION OF THE DRAWINGS

FIG. 1 is a block diagram illustrating the system overview of the present invention.

FIG. 2 is a flowchart illustrating the overall process followed by the method of the present invention.

FIG. 3 is a flowchart illustrating a sub-process for acquiring user data and/or records/files in order to generating an honesty and credibility rating for a specific user, business or entity of the present invention.

FIG. 4 is a flowchart illustrating an alternative embodiment of the sub-process for acquiring user data and/or records/files in order to generate an honesty and credibility rating for a specific user, business or entity of the present invention.

FIG. 5 is a flowchart illustrating a sub-process for validating the data received for the specific user, business or entity of the present invention.

FIG. 6 is a flowchart illustrating a sub-process for generating an honesty and credibility rating for the specific user, business or entity of the present invention.

FIG. 7 is a flowchart illustrating a sub-process for updating an honesty and credibility rating of a specific user, business or entity of the present invention.

FIG. 8 is a flowchart illustrating a sub-process for creating an obfuscated identity for a specific user, business or entity of the present invention.

FIG. 9 is a flowchart illustrating an alternative embodiment of the sub-process for creating the obfuscated identity with an image for the specific user, business or entity of the present invention.

FIG. 10 is a flowchart illustrating another embodiment of the sub-process for creating an obfuscated identity for a specific user, business or entity of the present invention, wherein user specified images may be used.

FIG. 11 is a flowchart illustrating another embodiment of the sub-process for creating an obfuscated identity for a specific user, business or entity of the present invention, wherein a quick response (QR) code is integrated with an image.

FIG. 12 is a flowchart illustrating another embodiment of the sub-process for creating an obfuscated identity for a specific user, business or entity of the present invention, wherein user identifying information may be removed.

FIG. 13 is a flowchart illustrating a sub-process for posting the obfuscated identity on social medial account for a specific user, business or entity of the present invention, wherein a uniform resource locator (URL) is used.

FIG. 14 is a flowchart illustrating an embodiment of the sub-process for creating an honesty and credibility rating for a specific user, business or entity of the present invention, wherein a uniform resource locator (QR) is used.

FIG. 15 is a flowchart illustrating a sub-process for relaying the resulting obfuscated identity with the honesty and credibility rating to the specific user, business or entity of the present invention.

FIG. 16 is a flowchart illustrating a sub-process for posting the resulting obfuscated identity with the honesty and credibility rating to social media for the specific user, business or entity of the present invention.

FIG. 17 is a flowchart illustrating the sub-process for generating an honesty and credibility rating for a specific user, business or entity of the present invention, wherein an exemplary algorithm is demonstrated.

### DETAILED DESCRIPTIONS OF THE INVENTION

All illustrations of the drawings are for the purpose of describing selected versions of the present invention and are not intended to limit the scope of the present invention.

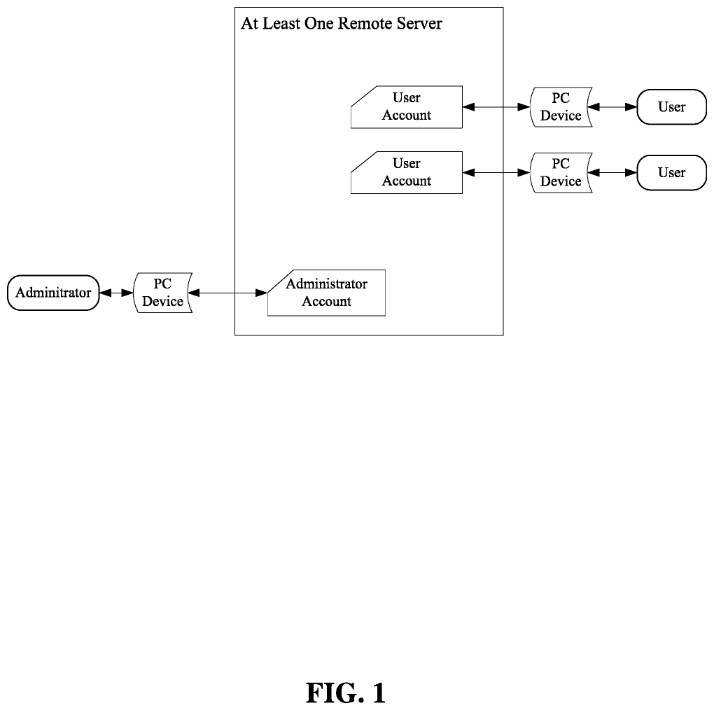

As can be seen in FIG. 1 to FIG. 17, the present invention comprises a system and method of creating and using an honesty and credibility rating for a specific user, business or entity. The present invention offers the user an honesty and credibility rating, for instance, including, but not limited to, a rating ranged from −10 to 10, with 10 being the highest score meaning excellent in regard to attributes of honesty and credibility of the user. The rating is not limited to a numerical range of −10 to 10. For example, the honesty and credibility rating can be expanded to −100 to 100, or any other ranges. Additionally, the honesty and credibility rating may include other characters such as A to Z, symbols, letters, different numbering systems, etc. The rating is created by the method based on the input data and information including, but not limited to, a background check report, a credit report, etc., that the user supplies or the method obtains through automatic acquisition means. Other reports can be supplied by the user and used by the method in the algorithm, which is unique to generating an integrated honesty and credibility rating and for creating an identification code that is combined with a profile of the user. The profile may only include general information of the user, subsequently the method of the present invention removes all personally identifiable information for the protection of the user's personal information through an innovative user identification and authentication process. In general, the present invention can be used in the following applications including, but not limited to, digital credentials, physical credentials, user credentials, entity credentials, employment leadership evaluation, investor evaluation, business partner evaluation, contract evaluation, marriage evaluation, dating evaluation, elections evaluation, finance evaluation, digital display, physical display, entity identification, authentication, authorization, access control, encryption, digital signatures, digital services, obfuscated identity, obscured identity, quantum key distribution, quantum cryptography, quantum computing, virtual reality, alternate reality, wired and wireless applications/communications, GEO (geographical) location, AI (Artificial Intelligence), machine learning, mobile computing, blockchain applications, etc.

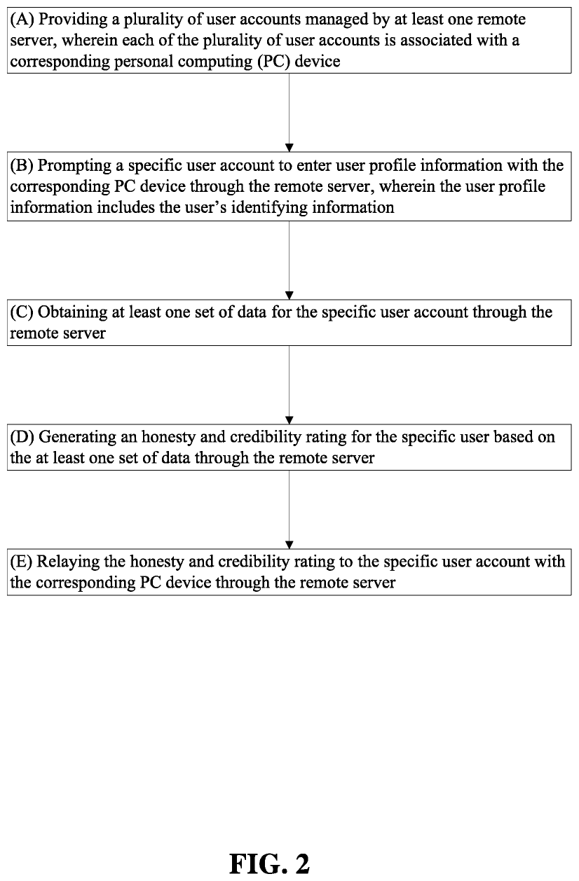

As can be seen in FIG. 1, the method of the present invention comprises a system and method to manage an honesty and credibility rating for a plurality of users. To accomplish this, the method of the present invention associates each of the plurality of users with a unique user account from a plurality of user accounts that are managed by at least one remote server (Step A), as seen in FIG. 2. Each of the plurality of user accounts is associated with a corresponding personal computing (PC) device. The corresponding PC device allows the user to interact with the present invention and can include, but is not limited to, a smartphone, a smart watch, a laptop, a desktop, a server, a server computer, a cloud computing device, a server terminal, a tablet PC, etc. The users of the user accounts may include relevant parties such as, but are not limited to, individuals, businesses, entities, consumers, managers, business owners, companies, corporations, associations, organizations, non-profit organizations, government entities, and administrators, etc. Further, the at least one remote server is used to manage the honesty and credibility rating system for the plurality of user accounts. The remote server can be managed through an administrator account by an administrator as seen in FIG. 1. The administrator who manages the remote server includes, but is not limited to, technician, engineer, system specialist, system administrator, software engineer, IT (information technology) specialist, IT professional, computer engineer, computer scientist, computer technologist, consultant, manager, owner, executive officer, chief operating officer, chief technology officer, chief executive officer, president, company, corporation, organization, association, etc. Moreover, the remote server is used to execute a number of internal software processes and store data for the present invention. The software processes may include, but are not limited to, server software programs, web-based software applications or browsers embodied as, for example, but not limited to, websites, web applications, desktop applications, and mobile applications compatible with a corresponding user PC device. Additionally, the software processes may store data into internal databases and communicate with external databases, which may include, but are not limited to, user profile databases, personal information databases, databases maintaining data about credit reports or background checks, etc. The interaction with external databases over a communication network may include, but is not limited to, the Internet.

As can be seen in FIG. 2, the overall process of the method of the present invention prompts a specific user account to enter user profile information with the corresponding PC device through the remote server, wherein the user profile information includes the user's identifying information (Step B). More specifically, the method prompts the specific user to enter data including, but not limited to, first name, middle name (if any), last name, etc., of the specific user in order to create a user account with a user profile. These pieces of information are essential to identify the user and they must match the information on any reports, documents, files, etc., that are later obtained for the rating system and/or the method acquires from external sources for creating an honesty and credibility rating for the user. With the appropriate user profile information, the method may create and display a unique identifier for the specific user account on the corresponding PC device through the remote server. The method generates a unique user identifier, including, but not limited to, a user account number, a member number, an alias, etc., and any data and/or records that tie the user, business or entity to the user and the user profile. Subsequently, the method obtains at least one set of data for the specific user account through the remote server (Step C). Specifically, the method may prompt the specific user to enter or upload the at least one set of data and/or files with the corresponding PC device through the remote server, wherein the specific user uploads data and/or files to be used to create the honest and creditability rating for the specific user account. Additionally, the method may acquire user data and/or files from external data/report sources using the information of the specific user. The at least one set of data and/or files include, but are not limited to, credit score, unpaid delinquent debt, unpaid collection, tax lien record, bankruptcy record, foreclosure record, civil judgement record, criminal record, traffic violations, violation of the law, social deed deemed negative against humanity, good deeds or actions for the good of humanity, background check report, credit report, any other suitable documents, etc. Upon receiving the at least one set of data and/or files, the method generates an honesty and credibility rating for the specific user based on the at least one report through the remote server (Step D). In the preferred embodiment of the present invention, a unique rating algorithm is used by the method to analyze the user, business or entity data and determines the honesty and credibility rating in this step. Subsequently, the method relays the honesty and credibility rating to the specific user account with the corresponding PC device through the remote server (Step E).

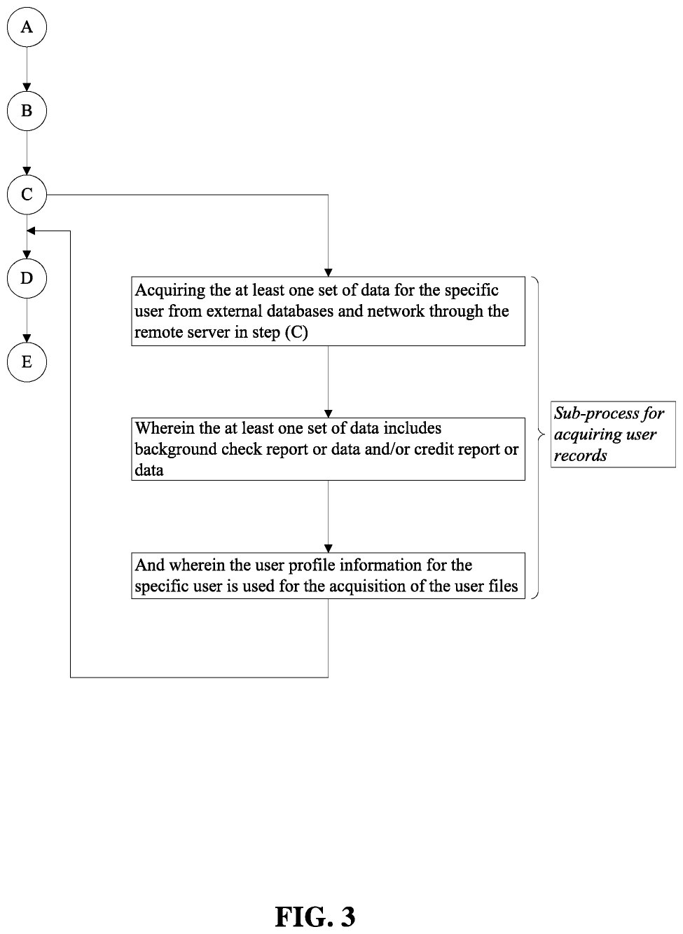

As can be seen in FIG. 3, the method provides a sub-process for acquiring user data and/or records, or files in order to create an honesty and credibility rating for the specific user. The term of record(s) is exchangeable with the term of file(s) and data. More specifically, the method acquires the at least one set of data for the specific user from external databases and network through the remote server in Step C, wherein the user provides at least one set of data including background check report or data and/or credit report or data, and wherein the user profile information for the specific user is used for the acquisition of the at least one set of data. The method of the present invention provides two approaches to obtain the user data/files, and/or records as input to generate the honesty and credibility rating for the specific user. One is by the specific user data entry interface provided by the present invention and the other the method itself.

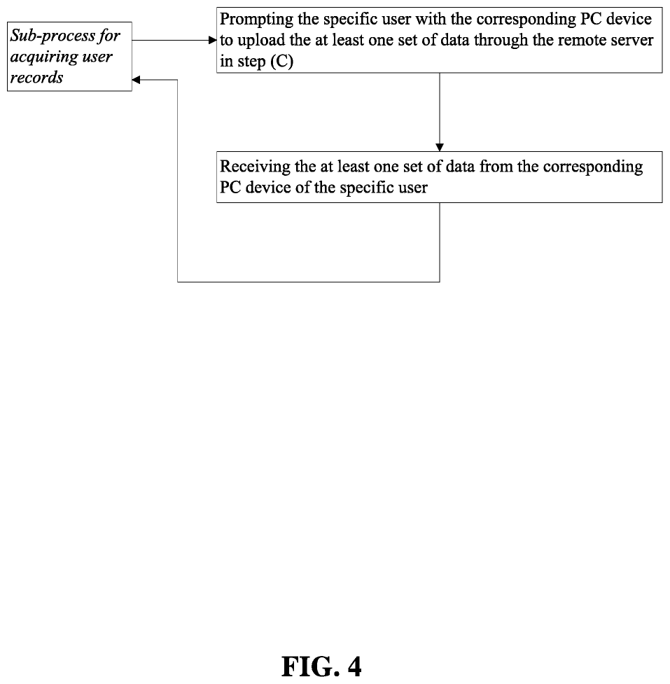

As can be seen in FIG. 4, in an alternative embodiment, the sub-process for acquiring user data and/or records/files of the method prompts the specific user with the corresponding PC device to upload the at least one set of data through the remote server in Step C, and receives the at least one set of data from the corresponding PC device of the specific user. The method may verify and require the specific user to upload files/data and/or records that provide valid information related to honesty and credibility rating process. Further, the method may use files/data and/or records obtained by entity with authority to issue credit data and/or records, including, but not limited, recognized credit bureaus, government entities, police departments, motor vehicle administrations, etc.

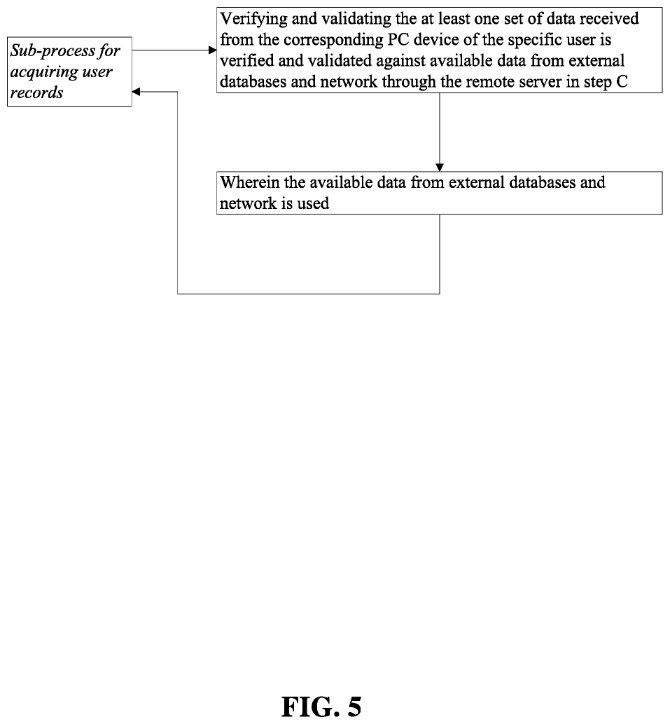

As can be seen in FIG. 5, in an alternative embodiment, the sub-process for acquiring user data and/or records/files of the method verifies and validates the specific user with the corresponding PC device to upload the at least one set of data the at least one set of data received from the corresponding PC device of the specific user is verified and validated against available data from external databases and network through the remote server in Step C, wherein the available data from external databases and network is used. The method may verify the at least one set of data, and/or records/files that is provided by the specific user against available data, and/or records/files acquired from external sources including, but not limited to, databases, data sources, official entities, etc. Once validated, the such data will be used in the honesty and credibility rating process. Otherwise, the method may notify the specific user that invalid data entered. Subsequently, the method may use the acquired data for the specific user to create the honesty and credibility rating or wait for the specific user to upload valid data.

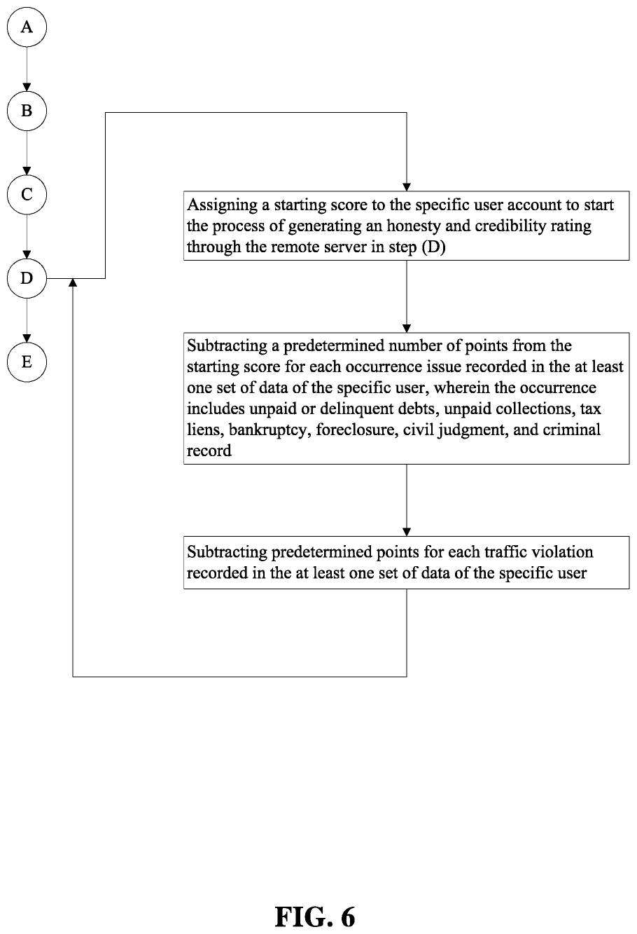

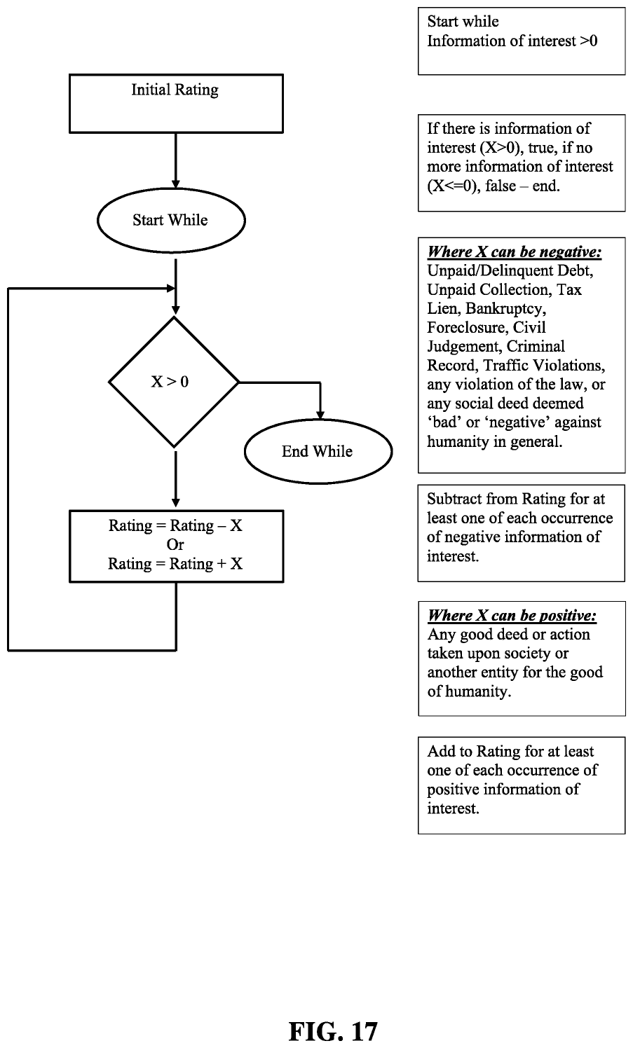

As can be seen in FIG. 6, the method provides a sub-process for generating an honesty and creditability rating for the specific user. Specifically, method assigns a starting score to the specific user account to start the process of generating an honesty and credibility rating through the remote server in Step D. Subsequently, the method subtracts a predetermined number of points or point from the starting score for each occurrence recorded in the at least one set of data of the specific user, wherein the occurrence includes unpaid or delinquent debts, unpaid collections, tax liens, bankruptcy, foreclosure, civil judgment, and criminal record. Further, the method subtracts predetermined points for each traffic violation recorded in the at least one set of data of the specific user. As can be seen in FIG. 17, in alternative embodiment of the present invention, the sub-process for generating an honesty and creditability rating of the method initiates the process by assigning an initial rating. Based on the information from the user data and/or records/files, the method either subtracts or adds predetermined points to the initial rating until all relevant information for the specific user is taken into account. For example, the method may subtract X point(s) from the initial rating for one occurrence including, but not limited to, unpaid/delinquent debt, unpaid collection, tax lien, bankruptcy, foreclosure, civil judgement, criminal record, traffic violation, violation of the law, social deed deemed “bad” or “negative” against humanity in general, etc. Further, the method may add X point(s) to the initial rating for one occurrence including, but not limited to, good deed, action taken upon society or another entity for the good of humanity, etc. The resulting honesty and credibility rating may be a positive and negative numerical value. Thus, a positive honesty and credibility rating indicates an honest and credible user, business or entity while a negative value can be improved by conducting good deeds to raise the honesty and credibility rating to a positive and/or desired value. An increasing honesty and credibility rating, over time, indicates that the specific user, business or entity can be trusted, is honest and credible. A decreasing honesty and credibility rating over time, however, means that the specific user, business or entity may not be trusted, and is not honest or credible. In any case where there is an excessive negative honesty and credibility rating, the specific user, business or entity should be questioned.

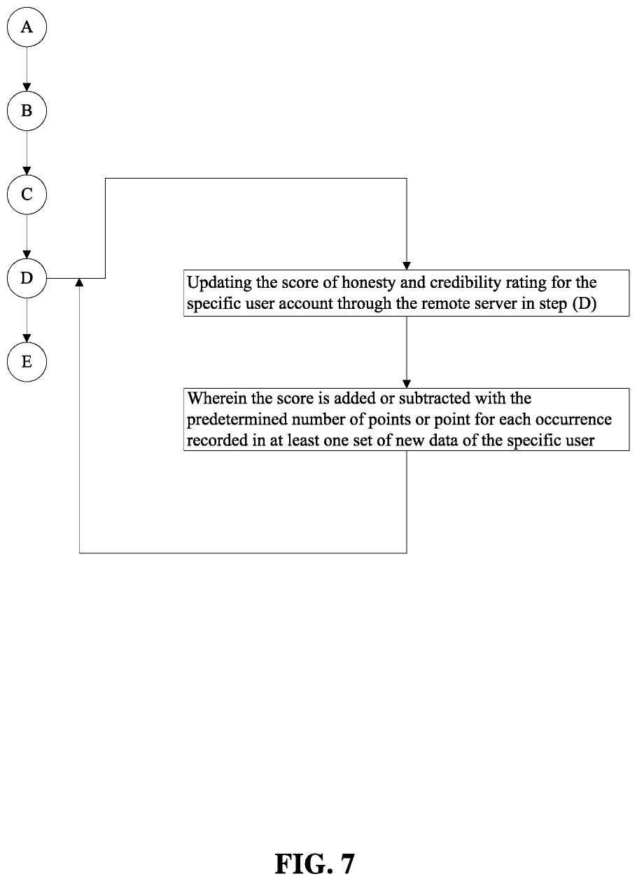

As can be seen in FIG. 7, the method provides a sub-process for updating an existing honesty and credibility rating for the specific user. Specifically, the method updates the score of honesty and credibility rating for the specific user account through the remote server in Step D, wherein the score is added or subtracted with the predetermined number of points for each occurrence recorded in at least one set of new data of the specific user. Through this sub-process, the method can update the existing honesty and credibility rating for the specific user through new data/records that are made available by either the specific user entered/uploaded information or the present invention acquiring from external databases. Further, the method may allow the specific user to request an update of the existing honesty and credibility rating conducted by the present invention at any time.

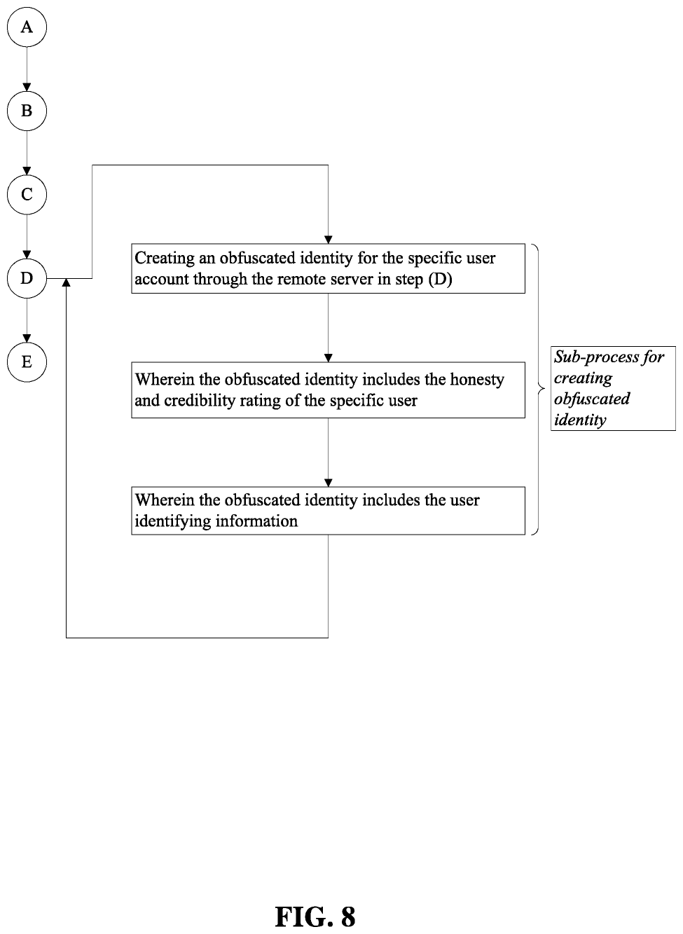

As can be seen in FIG. 8, the method provides a sub-process for creating an obfuscated identity for the specific user. Specifically, method creates an obfuscated identity for the specific user account through the remote server in Step D, wherein the obfuscated identity includes the honesty and credibility rating of the of the specific user, and wherein the obfuscated identity includes the user identifying information. The method of the present invention provides a secure identity, called obfuscated identity, which includes the honesty and credibility rating to the specific user. The obfuscated identity for the specific user can be embedded into a physical and/or digital badge or image for the specific user. The badge created can include, but is not limited to, a sticker, tag, card, logo, image, symbol, any set of pixels, etc. The badge can be created using any image that the present invention creates and/or the specific user desires.

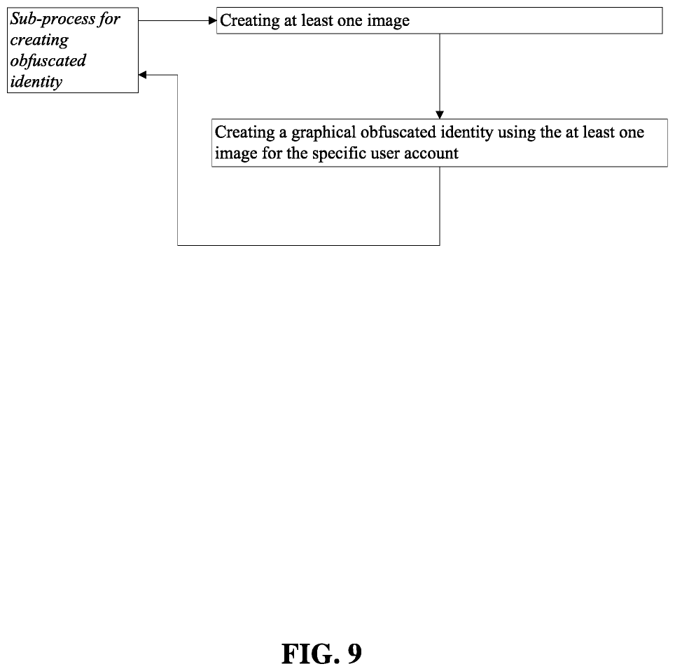

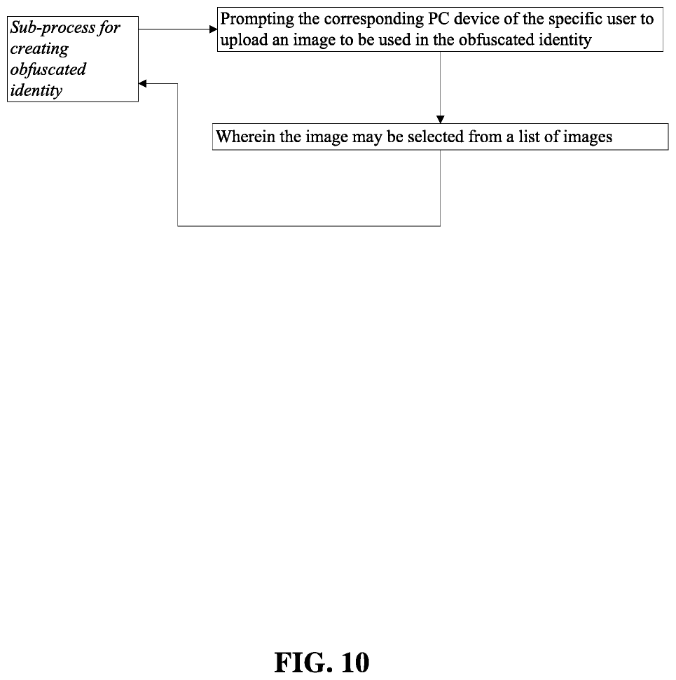

As can be seen in FIG. 9, in an embodiment of the present invention, this sub-process of the method creates at least one image and a graphical obfuscated identity using the at least one image for the specific user account. The resulting graphical obfuscated identity embedded with the honesty and credibility rating for the specific user can then be used in any suitable physical and digital forms. Further, as can be seen in FIG. 10, the method prompts the corresponding PC device of the specific user to upload an image to be used in the obfuscated identity, wherein the image may be selected from a list of images.

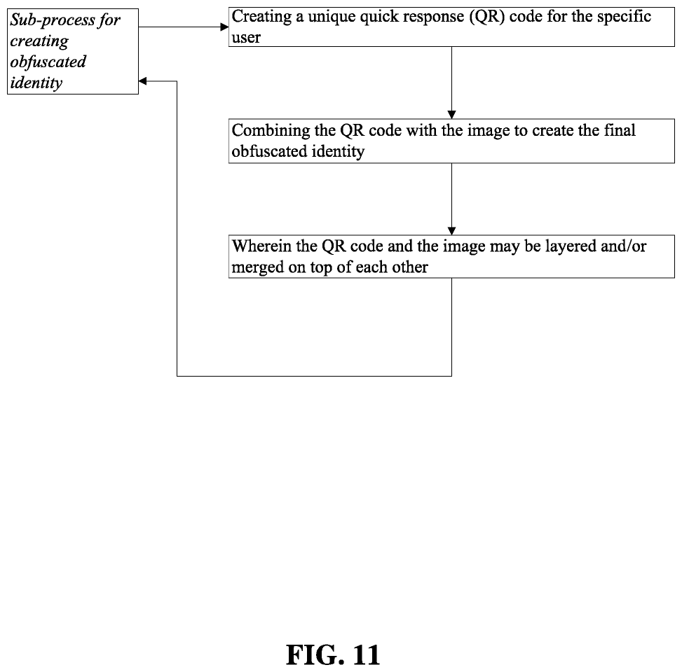

As can be seen in FIG. 11, in another embodiment of the present invention, the sub-process of the method creates a unique quick response (QR) code for the specific user, which combines the QR code with the image to create the final obfuscated identity, wherein the QR code and the image may be layered and/or merged on top of each other. Thus the obfuscated identity with the honesty and credibility rating for the specific user can include the QR code and the image for the specific user, which provides not only a secure and convenient honesty and credibility rating, but also a pleasing visual and aesthetic identity badge to the specific user.

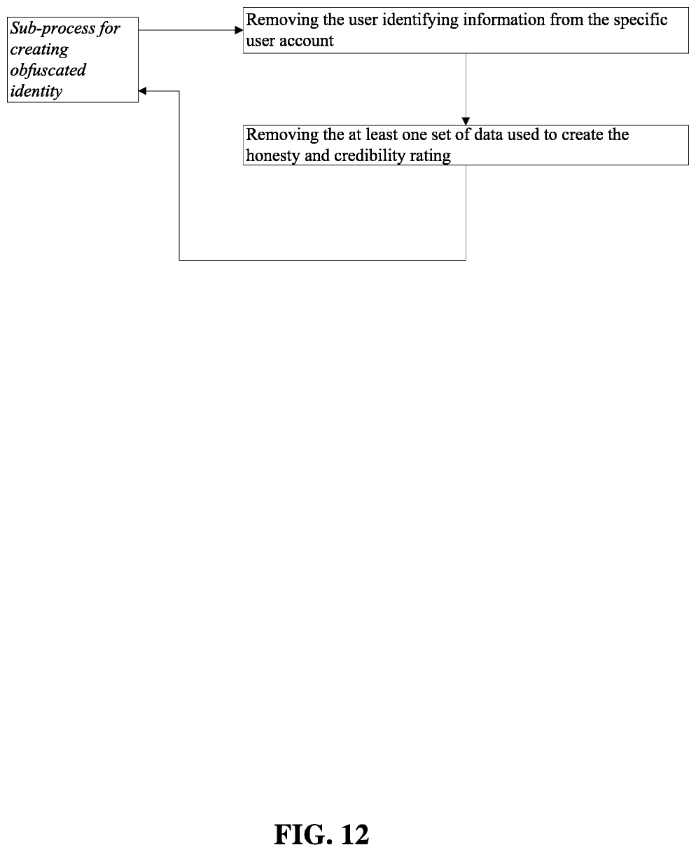

As can be seen in FIG. 12, in another embodiment of the present invention, the sub-process of the method may remove the user identifying information from the specific user account and the at least one set of data used to create the honesty and credibility rating. Once the obfuscated identity is created, the method may remove the user identifying information and at least one set of data from the specific user account. Thus, the obfuscated identity may only comprise the honesty and credibility rating, the user profile information, but not other private information for the specific user.

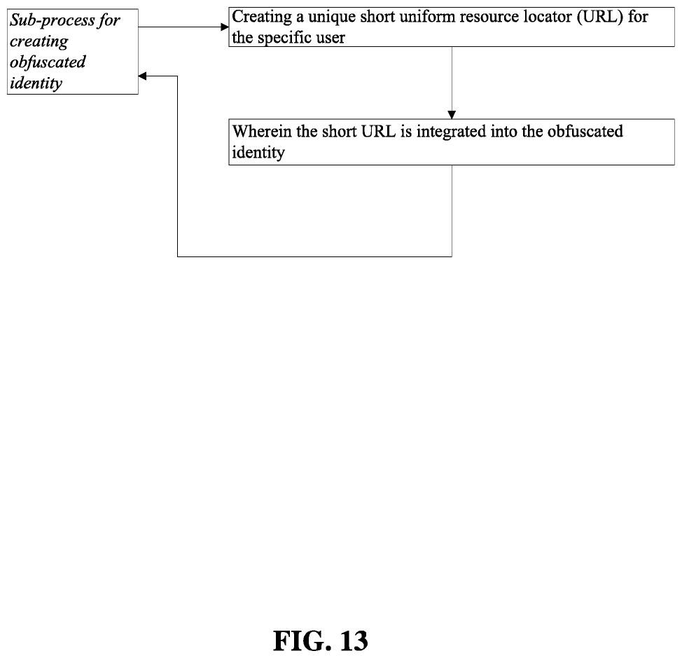

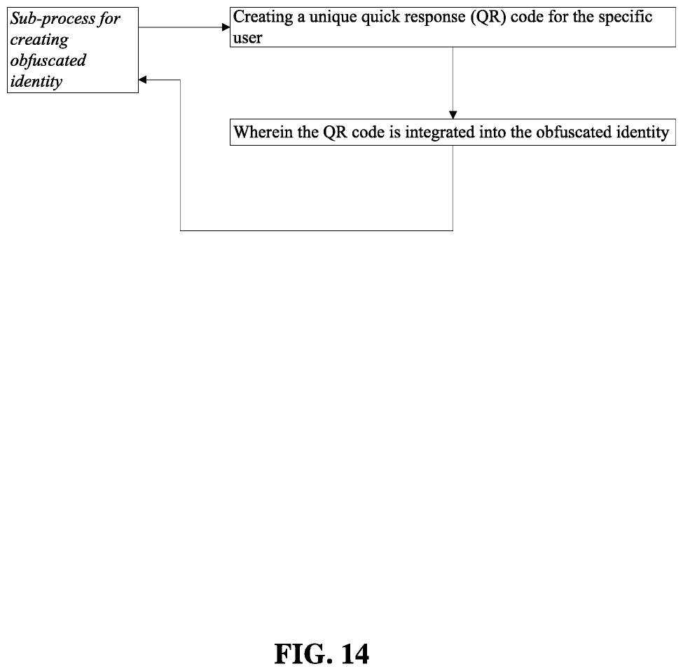

As can be seen in FIG. 13, in another embodiment of the present invention, the sub-process for creating an obfuscated identity for the specific user can also create a unique link for the specific user, business or entity. Specifically, the method creates a unique short uniform resource locator (URL) for the specific user, wherein the short URL is integrated into the obfuscated identity. As can be seen in FIG. 14, in another embodiment of the present invention, this sub-process of the method can create a unique quick response (QR) code for the specific user, wherein the QR code is integrated into the obfuscated identity through the remote server. Once the obfuscated identity is ready, the method sends the obfuscated identity to the corresponding PC device of the specific user through the remote server in Step E. The obfuscated identity can include, but is not limited to, the identifier number, the honesty and credibility rating, of the specific user. Additionally, the obfuscated identity may include, but is not limited to, a public key certificate, identity certificate, identity blockchain, QR code, URL, digital certificate, secure sockets layer (SSL), transport layer security (TLS), and/or any type of attachment to an electronic message used for security purposes, etc.

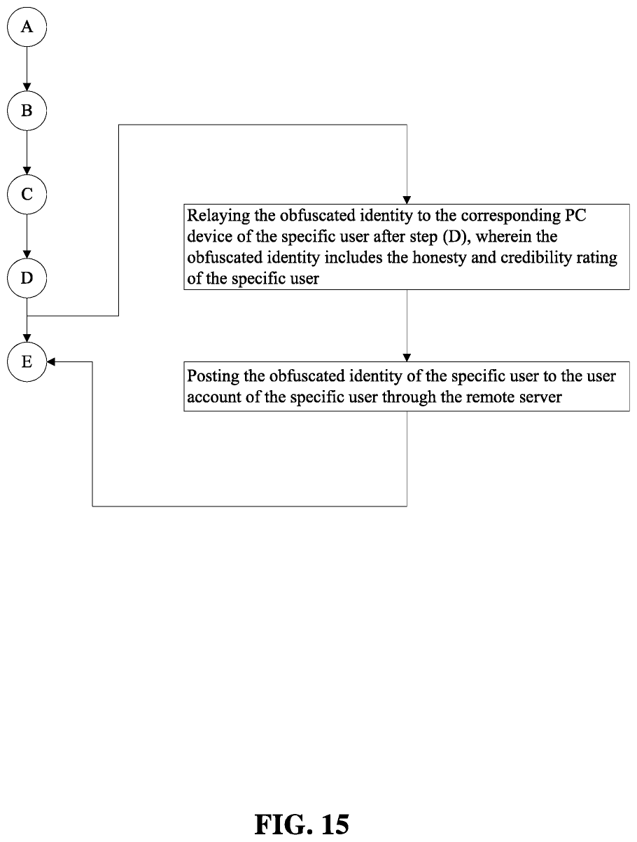

As can be seen in FIG. 15, the method may relay the obfuscated identity to the corresponding PC device of the specific user after Step D, wherein the obfuscated identity includes the honesty and credibility rating of the specific user. Subsequently, the method may post the obfuscated identity of the specific user to the user account of the specific user through the remote server. After the creation of the obfuscated identity for the specific user, the user profile information, the files/data and/or records used for generating the honesty and credibility rating, may have been deleted from the user account of the specific user. Thus, the method saves the more secure user identification—obfuscated identity into the user account of the specific user.

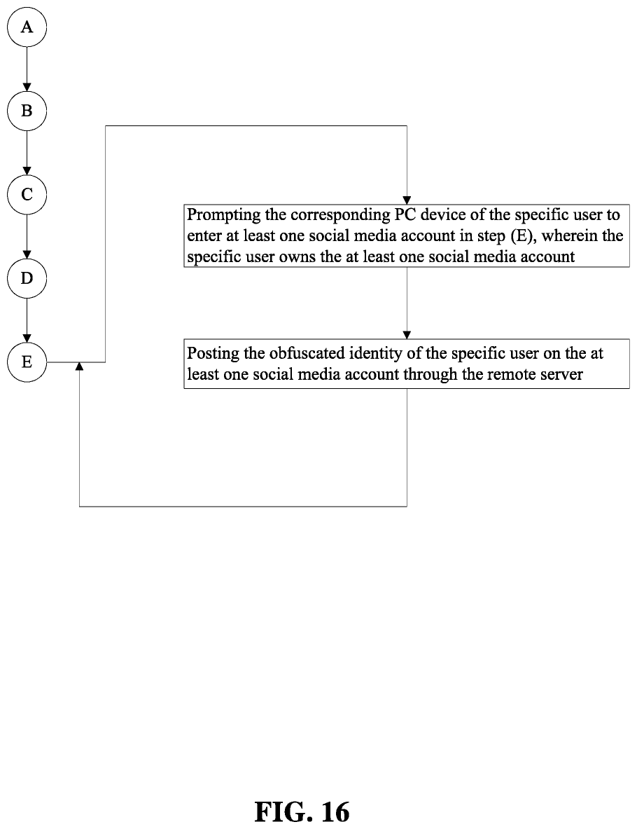

As can be seen in FIG. 16, the method provides a sub-process for posting the obfuscated identity to a social media site for the specific user. Specifically, method prompts the corresponding PC device of the specific user to enter at least one social media account in Step E, wherein the specific user owns the at least one social media account. Subsequently, the method posts the obfuscated identity of the specific user on the at least one social media account through the remote server. The at least one social media account may include, but is not limited to, LinkedIn®, Angie's List®, Facebook®, etc. Thus, the honesty and credibility rating and the associated obfuscated identity can be used in various social media, or even by government entities to provide valuable rating for users in a variety of social and governmental activities, proceedings, etc.

Although the invention has been explained in relation to its preferred embodiment, it is to be understood that many other possible modifications and variations can be made without departing from the spirit and scope of the invention as hereinafter claimed.

What is claimed is:

1. A method for providing an honesty and credibility rating, the method comprising the steps of:
(A) providing a plurality of user accounts managed by at least one remote server, wherein each of the plurality of user accounts is associated with a corresponding personal computing (PC) device;
(B) prompting a specific user account to enter user profile information with the corresponding PC device through the remote server, wherein the user profile information includes the user's identifying information;
(C) obtaining at least one set of data for the specific user account through the remote server;
(D) generating an honesty and credibility rating for the specific user based on the at least one set of data through the remote server;
(E) relaying the honesty and credibility rating to the specific user account with the corresponding PC device through the remote server.

2. The method for providing an honesty and credibility rating as claimed in claim 1, the method comprising the steps of:
acquiring the at least one set of data for the specific user from external databases and network through the remote server in step (C);
wherein the at least one set of data includes background check report or data and/or credit report or data; and
wherein the user profile information for the specific user is used for the acquisition of the at least one set of data.

3. The method for providing an honesty and credibility rating as claimed in claim 2, the method comprising the steps of:
prompting the specific user with the corresponding PC device to upload the at least one set of data through the remote server in step (C); and
receiving the at least one set of data from the corresponding PC device of the specific user.

4. The method for providing an honesty and credibility rating as claimed in claim 3, the method comprising the steps of:
verifying and validating the at least one set of data received from the corresponding PC device of the specific user is verified and validated against available data from external databases and network through the remote server in step (C); and
wherein the available data from external databases and network is used.

5. The method for providing an honesty and credibility rating as claimed in claim 1, the method comprising the steps of:
assigning a starting score to the specific user account to start the process of generating an honesty and credibility rating through the remote server in step (D);
subtracting a predetermined number of point from the starting score for each occurrence issue recorded in the at least one set of data of the specific user, wherein the occurrence issues include unpaid or delinquent debts, unpaid collections, tax liens, bankruptcy, foreclosure, civil judgment, and criminal record; and
subtracting predetermined points for each traffic violation recorded in the at least one set of data of the specific user.

6. The method for providing an honesty and credibility rating as claimed in claim 5, the method comprising the steps of:
updating the score of honesty and credibility rating for the specific user account through the remote server in step (D); and
wherein the score is added with or subtracted by the predetermined number of points or point for each occurrence issue recorded in at least one set of new data of the specific user.

7. The method for providing an honesty and credibility rating as claimed in claim 1, the method comprising the steps of:
creating an obfuscated identity for the specific user account through the remote server in step (D);
wherein the obfuscated identity includes the honesty and credibility rating of the specific user; and
wherein the obfuscated identity includes the user identifying information.

8. The method for providing an honesty and credibility rating as claimed in claim 7, the method comprising the steps of:
creating at least one image; and
creating a graphical obfuscated identity using the at least one image for the specific user account.

9. The method for providing an honesty and credibility rating as claimed in claim 8, the method comprising the steps of:
prompting the corresponding PC device of the specific user to upload an image to be used in the obfuscated identity; and
wherein the image may be selected from a list of images.

10. The method for providing an honesty and credibility rating as claimed in claim 8, the method comprising the steps of:
creating a unique quick response (QR) code for the specific user;
combining the QR code with the image to create the final obfuscated identity; and
wherein the QR code and the image may be layered and/or merged on top of each other.

11. The method for providing an honesty and credibility rating as claimed in claim 7, the method comprising the steps of:
removing the user identifying information from the specific user account; and
removing the at least one set of data used to create the honesty and credibility rating.

12. The method for providing an honesty and credibility rating as claimed in claim 7, the method comprising the steps of:
creating a unique short uniform resource locator (URL) for the specific user; and
wherein the short URL is integrated into the obfuscated identity.

13. The method for providing an honesty and credibility rating as claimed in claim 7, the method comprising the steps of:
creating a unique quick response (QR) code for the specific user; and
wherein the QR code is integrated into the obfuscated identity.

14. The method for providing an honesty and credibility rating as claimed in claim 7, the method comprising the steps of:
relaying the obfuscated identity to the corresponding PC device of the specific user after step (D), wherein the obfuscated identity includes the honesty and credibility rating of the specific user; and
posting the obfuscated identity of the specific user to the user account of the specific user through the remote server.

15. The method for providing an honesty and credibility rating as claimed in claim 1, the method comprising the steps of:
prompting the corresponding PC device of the specific user to enter at least one social media account in step (E), wherein the specific user owns the at least one social media account; and
posting the obfuscated identity of the specific user on the at least one social media account through the remote server.
